(19) United States
(12) Patent Application Publication
(10) Pub. No.: US 2021/0195924 A1
(43) Pub. Date: Jul. 1, 2021

(54) PHOTODYNAMIC INACTIVATION METHOD OF SALMONELLA

(71) Applicant: SHANGHAI OCEAN UNIVERSITY, Shanghai (CN)

(72) Inventors: Yong ZHAO, Shanghai (CN); Huihui LI, Shanghai (CN); Jingjing WANG, Shanghai (CN); Haiquan LIU, Shanghai (CN); Bowen CHEN, Shanghai (CN); Jiaming HUANG, Shanghai (CN)

(21) Appl. No.: 17/124,623

(22) Filed: Dec. 17, 2020

(30) Foreign Application Priority Data
Dec. 26, 2019 (CN) 201911366305.3

(51) Int. Cl. A23L 3/3544; A23L 3/26

(52) U.S. Cl. CPC A23L 3/3544; A23V 2002/00; A23L 3/26

(57) ABSTRACT

The present invention discloses a photodynamic inactivation method of Salmonella. The method using riboflavin as a photosensitizer adopts a blue light source to photodynamically inactivating Salmonella, which belongs to the technical field of sterilization for inactivating food-borne pathogenic Salmonella. The photosensitizer used in the present invention is one of essential vitamins of the human body. The riboflavin (a food-grade photosensitizer) is safe and non-toxic, and has a significant effect for inactivation of Salmonella. Moreover, the present invention is capable of controlling the risk of salmonellosis, short in treatment time, simple in operation, and capable of thoroughly inactivating Salmonella, and has certain control and prevention effects. The present invention provides a method for effective inactivation of Salmonella in food, which is low in cost, simple in operation and wide in application and can better promote the development of the food sterilization technology.

### CROSS-REFERENCE TO RELATED APPLICATIONS

This application claims the benefit of priority from Chinese Patent Application No. 201911366305.3, filed on Dec. 26, 2019. The content of the aforementioned applications, including any intervening amendments thereto, is incorporated herein by reference in its entirety

### TECHNICAL FIELD

The present invention relates to a sterilization technology for food-borne pathogenic Salmonella, and particularly relates to a photodynamic inactivation method of Salmonella.

### BACKGROUND OF THE PRESENT INVENTION

As malignant events of food safety occur frequently worldwide in recent years, the problems of food pollution and food-borne diseases have constituted a huge worldwide public health problem, and also became an important factor hindering the international food trade development. Salmonella is a major pathogen of global food-borne diseases. It has invasiveness, and may release endotoxin having high heat resistance after lysis. In recent years, cases of food poisoning caused by Salmonella have topped the list of various poisoning events. Moreover, Salmonella is highly resistant to different external environments, and can survive for months in water, milk, and meat products. At the same time, Salmonella cells include cold shock proteins (CspH), and can survive below the food refrigeration temperature (5° C.). Therefore, bacterial food poisoning caused by Salmonella brings great adverse consequences to human life and health and property safety, and also brings new challenges to control and prevention of the food-borne diseases.

At present, sterilization means of the food industry mainly include two categories, i.e. a traditional thermal sterilization technology and a new non-thermal sterilization technology (such as ultra-high pressure, pulsed electric field, pulsed strong light, irradiation, microwaves and other technologies). The traditional thermal sterilization technology is early in application, mature in technique and thorough in sterilization in the food industry, which can ensure safety of foods in microorganisms, but may destroy nutritional ingredients, tissue structures, colors and flavor of the food products. Although some of existing non-thermal sterilization technologies have met the requirements of people for both the food safety and food quality, they always have the disadvantages of high equipment investment and running cost, large energy consumption and high requirement for cold-chain transportation conditions.

Photodynamic inactivation (PDI) is a novel method capable of selectively inactivating malignant tumor cells and pathogenic microorganisms and viruses. A main principle of the method is to excite the non-toxic photosensitizer under the irradiation of the laser with a specific wavelength, and transfer energy to the surrounding oxygen by the excited photosensitizer to generate highly active singlet oxygen. The singlet oxygen is an active oxygen substance with high oxidation effect and can destroy macromolecular structures of cells, resulting in injury and even death of the cells, thereby achieving a purpose of inactivating the malignant tumor cells and pathogenic microorganisms. The PDI technology is economic, environment-friendly, green, safe, broad-spectrum, efficient and capable of maintaining characteristics of the foods such as the nutritional ingredients, tissue structures and product colors to the utmost extent. Researching and developing the PDI technology is becoming a research hotspot of the food industry.

However, researches have indicated that the effect of a photodynamic action has a great relationship with bacterial species, and Gram-negative bacteria are generally insensitive to the photodynamic inactivation. For example, Lei Tang et al. used a chlorophyll degradation product chlorophyllin ester as the photosensitizer for the PDI, and the research result showed that the chlorophyllin ester had a significant photodynamic inactivation effect on the Gram-positive bacteria Staphylococcus aureus, but had no influence on the growth of the Gram-negative bacteria Escherichia coli. Results of the research made by Yeshayahu et al. also showed that PDI with a low dose of a porphyrin compound serving as a photosensitizer had a significant inhibitory effect on 60 strains of 69 strains of Gram-positive bacteria, but had a weak inhibitory effect only on 150 strains of 247 strains of Gram-negative bacteria. Therefore, for different microorganisms, especially for the Gram-negative bacteria, to develop the photosensitizer with better and safer sterilization effect is a difficulty for researching the PDI technology. The existing PDI technology has undesirable sterilization effect on Salmonella in food, or the used photosensitizer does not belong to food additives. For example, Buchovec et al. used 5-aminolevulinic acid (ALA) as the photosensitizer and used an LED light with a wavelength of 400 nm as a light source. When irradiance of 20 mW/cm² is used to provide a dose of 24 J/cm², it is observed that Salmonella population is decreased by 4 to 6 Log CFU/mL. However, ALA does not belong to the food additive and cannot be used in food. In addition, the excessive dose of light energy causes great harm to the human body.

In 1899, Wynter Blyth, a British chemist, extracted a bright yellow pigment from milk and named it lactoflavin, i.e. riboflavin. The riboflavin refers to B vitamins of the same category, is also an essential vitamin of the human body, and plays an important role in improving metabolism of organisms and promoting growth and development of the human body.

In recent years, a lot of researches have already confirmed applications of riboflavin serving as a photosensitizer in the fields of killing tumors, cancer cells, diseases and insect pests. For example, from the researches made by Zhiyong Wang et al., it was found that, under ultraviolet radiation, vesicular stomatitis virus can be killed with 300 μmol/L of riboflavin under 10 minutes. However, up to now, there are extremely few reports about the application of the PDI technology using the riboflavin as the photosensitizer in the field of food safety. Therefore, based on the function and medical application of the riboflavin, it is expected that the riboflavin-mediated photodynamic technology is applied to the field of food safety, thereby improving the food safety.

Therefore, to inactivate Gram-negative bacteria by utilizing the PDI technology, particularly Salmonella in the foods, the photosensitizer that can be applied to the foods is urgently needed, such as the riboflavin. However, there is no photodynamic method using the riboflavin as the photosensitizer to inactivate Salmonella in the prior art.

### SUMMARY OF THE PRESENT INVENTION

The purpose of the present invention is to overcome the defects in the prior art and to provide a photodynamic inactivation method of Salmonella.

The purpose of the present invention is achieved through the following technical solutions:

The present invention provides the photodynamic inactivation method of Salmonella. The method includes the following steps:

(1) mixing the photosensitizer riboflavin and the to-be-treated sample;

(2) incubating the mixed sample under a dark condition;

(3) illuminating the sample after the dark incubation with a blue light source.

The dark incubation is as follows: the incubation is carried out under a dark condition after a photosensitizer riboflavin solution is mixed with the to-be-treated sample, so that the riboflavin can be well combined with Salmonella in the to-be-treated sample.

A wavelength of the blue light source is 455 to 460 nm.

A concentration of the riboflavin in a to-be-treated sample mixed system is 100 to 300 μmol/L.

Preferably, the concentration of the riboflavin in the to-be-treated sample mixed system is 150 to 200 μmol/L.

The illumination light energy density of the blue light source is 6 to 16 J/cm².

Preferably, the illumination light energy density of the blue light source is 9.36 to 15.6 J/cm².

Preferably, the illumination light energy density of the blue light source is 12.48 to 15.6 J/cm².

The illumination time of the blue light source is greater than or equal to 20 min.

Preferably, the illumination time of the blue light source is 20 to 50 min.

Further, the illumination time of the blue light source is 30 to 50 min.

In step (3), when the blue light source is used for illumination, only the blue light source is used, and the illumination of other light sources is prevented.

The blue light source is an LED blue light source.

In step (2), the dark incubation time is 35 to 50 min.

Preferably, the dark incubation time is 40 to 45 min, and more preferably 40 min.

Preferably, in step (3), the light illumination intensity of the blue light source is 5.2 mW/cm². A distance between the blue light source and the to-be-treated sample is 5 cm.

Preferably, the riboflavin concentration in the to-be-treated sample mixed system is 150 to 200 μmol/L, the dark incubation time is 30 to 50 min, and the illumination light energy density of the blue light source is 9.36 to 15. 6 J/cm².

The photodynamic inactivation method of Salmonella provided by the present invention is a sterilization method of specifically inactivating Salmonella by compounding a blue light source and riboflavin. Compared with the prior art, the present invention has the following beneficial effects:

1. The method creatively combines the riboflavin that is an essential vitamin of the human body with the blue light source of 455 to 460 nm to establish a novel riboflavin-mediated PDI method for inactivating Salmonella. The method has the advantages of simple operation, low cost and no pollution.

2. The riboflavin serving as the photosensitizer is one of the essential vitamins of the human body, belongs to the food-grade photosensitizer, is safe and nontoxic, and has significant effect on inactivation of Salmonella.

3. The present invention can control the risk of salmonellosis, is short in treatment time, small in illumination dose and simple and safe in operation, can thoroughly inactivate Salmonella, has certain control and prevention effect, and is suitable for inactivating and controlling Salmonella in food, thereby providing powerful technical support to reduce the disease risk of Salmonella and maintain the public health.

### BRIEF DESCRIPTION OF THE DRAWINGS

FIG. 1 Structural schematic diagram of a device of a 455-460 nm LED illumination system.

In the figure: 1—LED photographing light box; 2—lifting platform; 3—24-well plate; 4—LED blue light source.

FIG. 2 Effects of different riboflavin concentrations on photodynamic inactivation of Salmonella.

FIG. 3 Effects of different blue light source illumination time on photodynamic inactivation of Salmonella.

FIG. 4 Effects of different dark incubation time on photodynamic inactivation of Salmonella.

FIG. 5 Experimental effect of a photodynamic inactivation method of Salmonella in treating fresh eggs.

FIG. 6A-6F Effect diagram of riboflavin-mediated photodynamic inactivation on an outer membrane of Salmonella.

In the figure: 6A—negative reference group; 6B—single illumination group; 6C—single photosensitizer group; 6D—photodynamic experiment group I; 6E—photodynamic experiment group II; 6F—photodynamic experiment group III. Magnifications: A1-F1: 10000 times; A2-F2: 20000 times.

### DETAILED DESCRIPTION OF THE PRESENT INVENTION

### Preparation of Salmonella Bacterial Solution

Salmonella species used in embodiments are Salmonella typhimurium CICC 21484 and Salmonella enteritidis CMCC 50041 respectively. The Salmonella typhimurium CICC 21484 was bought from China Center of Industrial Culture Collection (CICC), and Salmonella enteritidis CMCC 50041 was bought from China Medical Culture Collection (CMCC).

A preparation method of Salmonella bacterial solution: standard strains Salmonella typhimurium CICC 21484 and Salmonella enteritidis CMCC 50041 stored in glycerin tubes at −80° C. were scribed and inoculated to bismuth sulfite agar plates and culture for 24 to 48 h at 37° C. Single colonies were picked into 9 mL TSB test tubes respectively and cultured for 13 h in a table concentrator with a rotation speed of 180 r/min at 37° C. to obtain a stable initial bacteria culture solution. Equal amounts of two Salmonella culture solutions were mixed in a centrifugal tube and centrifuged for 5 min (4° C., 4000 g). 0.85% sterile saline solution was used to re-suspend the bacteria. The concentration of the bacteria was adjusted to about 1×10⁷ CFU/mL.

### Preparation of the Riboflavin Solution

Riboflavin in embodiments was bought from a Sangong Biotechnological company, and it was under a USP grade.

A preparation method of the riboflavin solution: riboflavin was mixed with 0.85% sterile saline solution to prepare the riboflavin solution. The riboflavin solution was prepared for immediate use and stored in darkness at room temperature.

### Blue Light Source

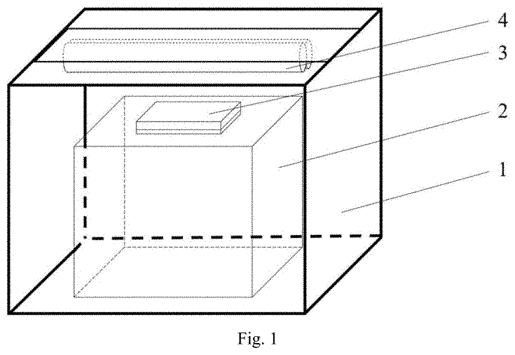

The blue light source in embodiments was an LED blue light source (455-460 nm, 30 cm, 5 W) and was bought from Shenzhen in China (Shenzhen Kerun Optoelectronics Inc., China). A structure of a blue light source illumination device is shown in FIG. 1. An LED system includes an LED photographing light box, a lifting platform and an LED blue light source. The LED system was surrounded by the LED photographing light box, so that the entrance of external light can be prevented. The LED blue light source is disposed at the top inner side of the LED photographing light box. The 24-well plate is disposed on the lifting platform. A distance between the LED blue light source and a sample solution in the 24-well plate (a diameter of 14 mm) is adjusted to 5.0 cm by the lifting platform. The illumination intensity of the LED blue light source is 5.2 mW/cm². An energy meter console (PM100D) with a photoelectric diode power sensor (S130C) (American Newton) was used for measurement. The following formula was used to calculate the dose of each obtained sample:

E=Pt

where E=Dose (energy density) in J/cm², P=Irradiance (power density) in W/cm², and t=time in sec.

As shown in FIG. 1, the lifting platform 2 is arranged inside the LED photographing light box 1. No dotted line is used to indicate the lifting platform 2, which does not affect those skilled in the art to understand a specific structure of a blue light illumination device.

Photodynamic Method for Treating Salmonella:

The riboflavin solution and the bacterial solution were mixed in a 5 mL centrifugal tube. In the mixed system, the concentration of the bacterial solution is about 1×10⁶ CFU/mL, and the riboflavin concentration is 0 μmol/L, 50 μmol/L, 100 μmol/L, 150 μmol/L, 200 μmol/L, 250 μmol/L and 300 μmol/L respectively. The mixed system was subjected to the dark incubation for a given time at the rotation speed of 2 r/min in a PTR-60 multifunctional vertical rotating mixer (the temperature is the room temperature: 22-25° C.). 500 μL mixed bacterial solution was sucked into the 24-well plate and illuminated by the LED blue light source with a wavelength of 455-460 nm for a given time. Thereafter, 0.85% sterile saline solution was used for dilution, and appropriate dilution degrees were selected. 100 μL diluent was coated on a plate, and then the plate was cultured for 24-48 h at 37° C. The number of bacterial colonies was calculated. Three parallel samples were prepared for each treatment. Each dilution degree was repeated for three times.

The PTR-60 multifunctional vertical rotating mixer was Grant-bio. A 9272 waterproof thermostatic incubator was from Shanghai Yiheng Sci-Tech Co., Ltd.

Data Analysis:

The experimental data were expressed as the mean±standard deviation. One-way analysis of variance was used to compare the value differences (P<0.05) using SPSS 17.0 (SPSS Inc., Chicago, Ill.).

Embodiments are used to describe the implementation of the present invention in detail below. An implementation process of the present invention for using the technical means to solve the technical problems and to achieve the technical effect is fully explained and implemented on this basis.

### Embodiment 1

### Effect Experiment of Different Riboflavin Concentrations on Photodynamic Inactivation of Salmonella

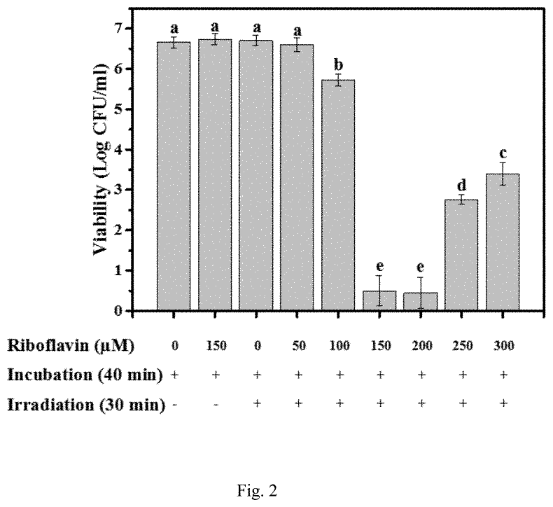

The experiment was carried out according to a photodynamic treatment method of Salmonella. The concentrations of the riboflavin solutions in the to-be-treated sample mixed system were 0 μmol/L, 50 μmol/L, 100 μmol/L, 150 μmol/L, 200 μmol/L, 250 μmol/L and 300 μmol/L respectively. The dark incubation time was 40 min. The illumination time of the LED blue light source was 30 min. FIG. 2 shows an inactivation status of Salmonella after being treated with different concentrations of riboflavin.

An initial inoculation amount of Salmonella in the system was about 4.5×10⁶ CFU/mL. When the riboflavin concentrations were 100 μmol/L, 150 μmol/L and 200 μmol/L, the amount of Salmonella could be reduced by 1.12 Log CFU/mL, 6.14 Log CFU/mL and 6.21 Log CFU/mL respectively with the incubation time of 40 min, the illumination time of 30 min. When the riboflavin concentrations were 150 μmol/L and 200 μmol/L respectively, the lethality of Salmonella can reach 99.99993% and 99.99995% respectively. When the riboflavin concentration was relatively low, with the increase of the concentration, the lethality of the photodynamic inactivation of Salmonella was improved. When the concentration reached 200 μmol/L, the lethality was maximal. When the riboflavin concentration is continuously increased, the lethality of Salmonella is apparently decreased. The possible reason is that the surplus photosensitizer in the solution absorbs a majority of light, so that the effective light of the photosensitizer on the surface of the bacteria is reduced, and the lethality of the bacteria is decreased. It is indicated that by selecting the appropriate riboflavin concentration, the inactivation effect on Salmonella can be improved.

According to the above photodynamic method for treating Salmonella, two groups of reference experiments were set.

The illumination time of the LED blue light source in one group was 0 min, the riboflavin concentration in the mixed system was 0 μmol/L, and the dark incubation time was 40 min. The illumination time of the LED blue light source in the other group was 0 min, the riboflavin concentration in the mixed system was 150 μmol/L, and the dark incubation time was 40 min. As shown in FIG. 2, when there is no riboflavin, no blue light, but only the dark incubation for treating the sample, or when there is only riboflavin and dark incubation but no blue light for treating the sample, the lethality of Salmonella was extremely low, and the sterilization effect was not significant.

### Embodiment 2

### Effect Experiment of Different Incubation Time on Photodynamic Inactivation of Salmonella

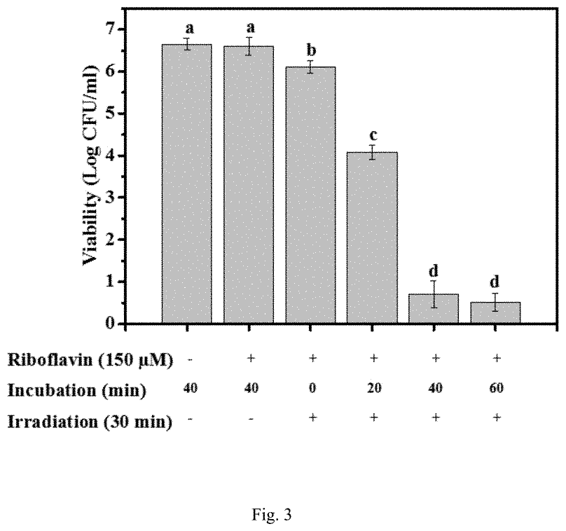

The experiment was carried out according to a photodynamic method for treating Salmonella. The riboflavin concentration in the mixed system was 150 μmol/L. The incubation time was 0 min, 20 min, 40 min and 60 min respectively. The illumination time of the LED blue light source was 30 min. As shown in FIG. 3, with the increase of the incubation time, the inactivation effect for Salmonella was also increased. When the incubation time was 40 min, the fatality rate of Salmonella was 99.99993%. However, the excessive long incubation time may also affect the sterilization effect. Therefore, selecting the appropriate incubation time can improve the inactivation effect for Salmonella.

According to the above photodynamic method for treating Salmonella, two groups of reference experiments were set. The illumination time of the LED blue light source in one group was 0 min, the riboflavin concentration in the mixed system was 0 μmol/L, and the dark incubation time was 40 min. The illumination time of the LED blue light source in the other group was 0 min, the riboflavin concentration in the mixed system was 150 μmol/L, and the dark incubation time was 40 min. As shown in FIG. 3, when there is no riboflavin, no blue light, but only dark incubation for treating the sample, or when there is riboflavin and only dark incubation but no blue light for treating the sample, the fatality rate of Salmonella was extremely low, and the sterilization effect was not significant.

### Embodiment 3

### Effect Experiment of Different Illumination Time on Photodynamic Inactivation of Salmonella

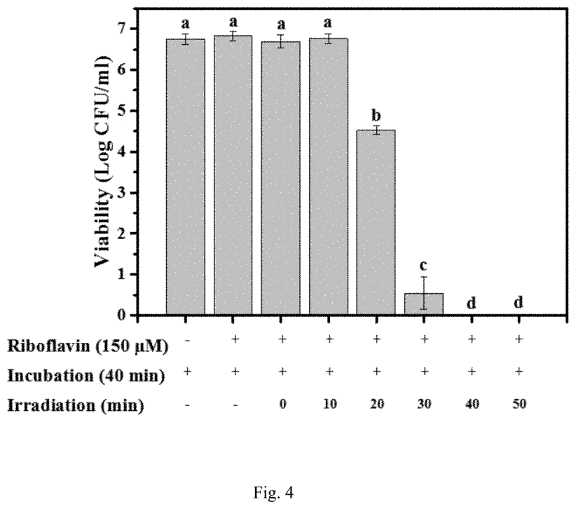

The experiment was carried out according to a photodynamic method for treating Salmonella. The riboflavin concentration in the to-be-treated sample mixed system was 150 μmol/L. The dark incubation time was 40 min. The illumination time of the LED blue light source was 0 min, 10 min, 20 min, 30 min, 40 min and 50 min. FIG. 4 shows an inactivation status of Salmonella after being treated with different illumination time. With the increase of the illumination time, the inactivation effect for Salmonella is also increased significantly. The initial inoculation amount of Salmonella in the system was about 6.75 Log CFU/mL. With the riboflavin concentration of 150 μmol/L, the incubation time of 40 min, and the illumination time of 20 min, 30 min, 40 min and 50 min, the amount of Salmonella can be reduced by 2.23 Log CFU/mL, 6.21 Log CFU/mL, 6.75 Log CFU/mL and 6.75 Log CFU/mL respectively. When the illumination time was 40 min, the fatality rate of Salmonella reached up to 99.99995%.

According to the above photodynamic method for treating Salmonella, two groups of reference experiments were set. The illumination time of the LED blue light source in one group was 0 min, the riboflavin concentration in the mixed system was 0 μmol/L, and the dark incubation time was 40 min. The illumination time of the LED blue light source in the other group was 0 min, the riboflavin concentration in the mixed system was 150 μmol/L, and the dark incubation time was 40 min. As shown in FIG. 4, when there is no riboflavin, no blue light, but only dark incubation for treating the sample, or when there is riboflavin and dark incubation but only no blue light for treating the sample, the fatality rate of Salmonella was extremely low, and the sterilization effect was not significant.

### Embodiment 4

### Salmonella Inactivation Experiment for Fresh Egg Shells

Sterile egg shells were mixed with a Salmonella bacterial solution to be contaminated and divided into three groups as follows: 1, a single photosensitizer group with riboflavin concentration of 150 μmol/L, was subjected to the dark incubation for 40 min without the illumination of a blue light source; 2, a photodynamic experiment group with riboflavin concentration of 150 μmol/L, was subjected to the dark incubation for 40 min under the illumination of the blue light source for 40 min; and 3, a blank reference group with a saline solution having a volume equal to that of the riboflavin solution. Each group was provided with two parallel groups.

Bacteria culture: under a sterile condition, each group of egg shells was diluted with the saline solution for two times and then homogenized by a sterile homogenizing device and diluted. 100 μL diluent with appropriate dilution degrees was inoculated into the TSA solid culture medium and cultured for 24 to 48 h in the thermostatic incubator at 37° C. The number of bacterial colonies in each group was counted.

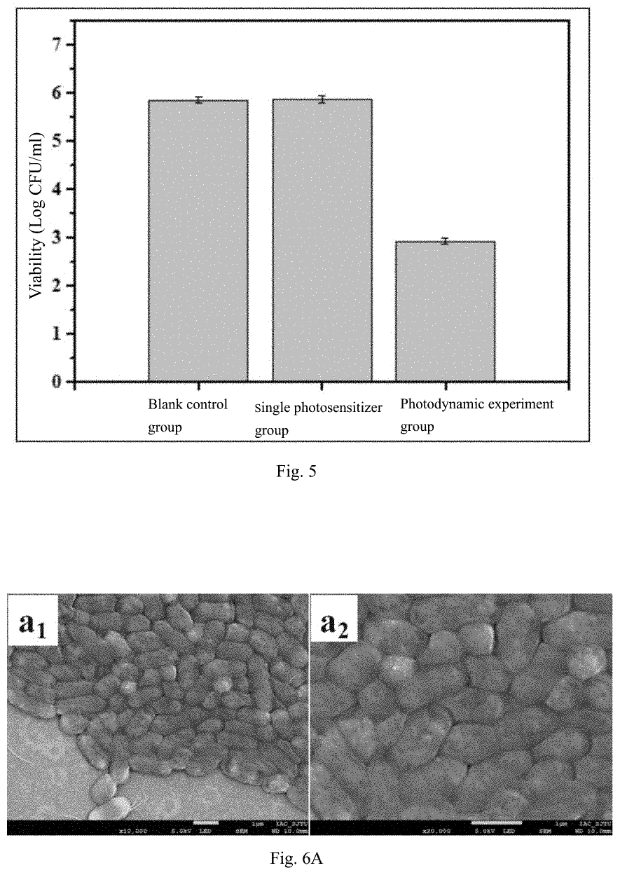

As shown in FIG. 5, the result shows that the number of Salmonella bacterial colonies in the blank reference group of egg shells is 7.4×10⁵ CFU/g, the number of the bacterial colonies in the egg shells after the PDI treatment is 8.4×10² CFU/g, and the number of the bacterial colonies in the egg shells of the single photosensitizer group is 7.0×10⁵ CFU/g. Through multiple experiments, it is discovered that the sterilization rate of the photodynamic inactivation method of Salmonella using the riboflavin as the photosensitizer can reach 99.88%, and the sterilization effect is apparent.

### Embodiment 5

### Effect Diagram of a Riboflavin-Mediated PDI Method on an Outer Membrane of Salmonella

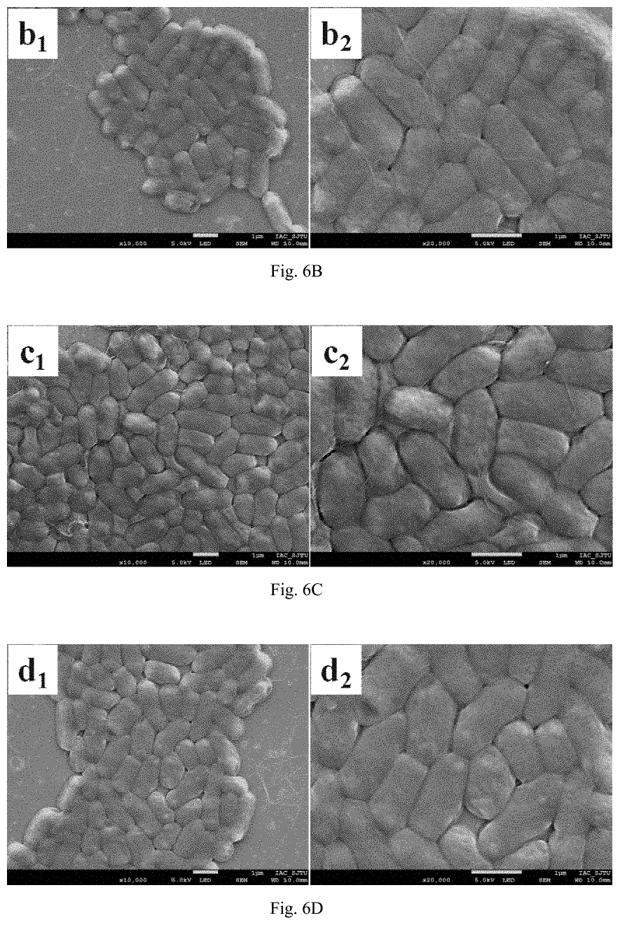

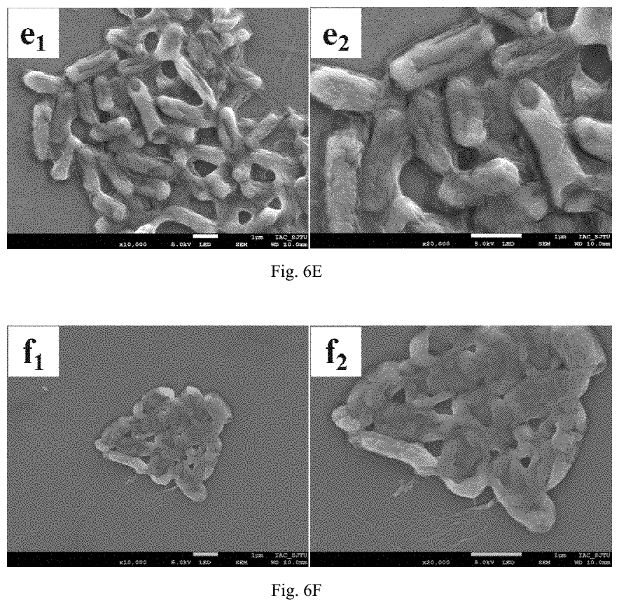

The bacterial solution was treated under different conditions. As shown in FIG. 6, FIG. 6A is a negative reference group: this group was a pure bacterial solution without any treatment. FIG. 6B is a single illumination group: with no riboflavin solution, the bacterial solution was not subjected to the dark incubation but only illuminated with the blue light source with the illumination energy density of 15.6 J/cm². FIG. 6C is a single photosensitizer group: with 150 μmol/L riboflavin solution, the bacterial solution was subjected to the dark incubation for 40 min without the illumination of the blue light source. FIG. 6D is a photodynamic experiment group I: with 50 μmol/L riboflavin solution, the bacterial solution was subjected to the dark incubation for 20 min and illuminated with the blue light source with the illumination energy density of 3.12 J/cm². FIG. 6E is a photodynamic experiment group II: with 150 μmol/L riboflavin solution, the bacterial solution was subjected to the dark incubation for 40 min and illuminated with the blue light source with the illumination energy density of 9.63 J/cm². FIG. 6F is a photodynamic experiment group III: with 150 μmol/L riboflavin solution, the bacterial solution was subjected to the dark incubation for 40 min and illuminated with the blue light source with the illumination energy density of 15.6 J/cm².

Bacterial suspension (500 μL) was centrifuged for 5 min at 10,000 g. Supernatant was removed, and precipitates were mixed with 500 μL glutaraldehyde (2.5%) and formaldehyde (4%) in 0.1M Cacodylate buffer for overnight at 4° C. Then the sample was gradually dehydrated level by level through a consecutive 30%-100% ethanol solution. The sample was placed on a support by using double-sided transparent adhesive and coated with gold. A high-resolution desktop SEM (SNE-4500M, JEOL, Japan) was used for scanning, and results are shown in FIG. 6.

A scanning electron microscope (SEM) was used to represent morphologic change of bacteria cells. Compared with the negative reference group (FIG. 6A), the morphology of Salmonella cells in the single illumination group (FIG. 6B) and the single photosensitizer group (FIG. 6C) is not apparently changed, as shown in FIGS. 6B-C, and the cells are in a full rhabditiform. As shown in FIG. 6D, the surfaces of the cells in the photodynamic experiment group I had slight morphological deformation and grooves. As shown in FIG. 6E, the apparent deformed morphology of the cells and the fold cells can be observed in the photodynamic experiment group II. As shown in FIG. 6F, in the photodynamic experiment group III, the morphologic deformation of Salmonella cells is significantly changed, and a great number of cells are broken. Therefore, it can be concluded that the riboflavin-mediated PDI may inactivate Salmonella by attacking cell walls and cell membranes.

The above only describes specific embodiments of the present invention, but the protection scope of the present invention is not limited thereto. Any changes or replacements made without contributing creative effort shall fall within the protection scope of the present invention. Therefore, the protection scope of the present invention shall be subjected to the protection scope defined by the claims.

What is claimed is:

1. A photodynamic inactivation method of Salmonella, comprising the following steps:
(1) mixing riboflavin serving as a photosensitizer and a to-be-treated sample;
(2) incubating the mixed sample under a dark condition; and
(3) illuminating the sample after the dark incubation with a blue light source.

2. The photodynamic inactivation method of Salmonella according to claim 1, wherein a wavelength of the blue light source is 455 to 460 nm.

3. The photodynamic inactivation method of Salmonella according to claim 1, wherein in the step (1), a concentration of the riboflavin in a to-be-treated sample mixed system is 100 to 300 μmol/L.

4. The photodynamic inactivation method of Salmonella according to claim 1, wherein in the step (1), the concentration of the riboflavin in the to-be-treated sample mixed system is 150 to 200 μmol/L.

5. The photodynamic inactivation method of Salmonella according to claim 1, wherein in the step (3), when the blue light source is used for illumination, only the blue light source is used, and the illumination of other light sources is prevented.

6. The photodynamic inactivation method of Salmonella according to claim 1, wherein in the step (3), the illumination light energy density of the blue light source is 6 to 16 J/cm².

7. The photodynamic inactivation method of Salmonella according to claim 1, wherein in the step (3), the illumination light energy density of the blue light source is 9.36 to 15.6 J/cm².

8. The photodynamic inactivation method of Salmonella according to claim 1, wherein in the step (3), the illumination light energy density of the blue light source is 12.48 to 15.6 J/cm².

9. The photodynamic inactivation method of Salmonella according to claim 1, wherein, in the step (2), the dark incubation time is 35 to 50 min.

10. An application of the riboflavin serving as the photosensitizer in inactivation of Salmonella.
